(19) United States
(12) Patent Application Publication
(10) Pub. No.: US 2011/0216019 A1
(43) Pub. Date: Sep. 8, 2011

(54) TOUCH-SENSITIVE PANEL ASSEMBLY

(76) Inventor: Yen-Te HSIAO, Hsinchuang City (TW)

(21) Appl. No.: 12/900,487

(22) Filed: Oct. 8, 2010

(30) Foreign Application Priority Data
Mar. 3, 2010 (TW) 099203782

(51) Int. Cl. G06F 3/041

(52) U.S. Cl. 345/173; 178/20.01

(57) ABSTRACT

The touch-sensitive panel assembly contains a back frame, a front piece, a disk module, and a panel module. The back frame contains a back piece and two lateral pieces, forming a U-like shape. The back piece has a cable opening and a connector opening. Along an inner surface adjacent to a front end of each lateral piece, two first fastening elements and a second fastening element, each with a bolt hole, are vertically arranged in this sequence. The front piece has a number of third fastening elements on a back surface, each corresponding to a first fasting element. The third fastening elements are threaded through the panel module and locked to the first fastening elements by a number of bolts. The disk module is positioned beneath the front piece and the panel module. The disk module has fourth fastening elements corresponding to the second fastening elements of the back frame. A number of bolts are driven to lock the fourth and second fastening elements together.

### (a) TECHNICAL FIELD OF THE INVENTION

The present invention generally relates to touch-sensitive panels, and more particularly to a simplified yet robust structure incorporating a touch-sensitive panel.

### (b) DESCRIPTION OF THE PRIOR ART

A conventional touch-sensitive panel assembly usually has a panel in the front, and various disk slots and switches are configured along the lateral sides. Its appearance is less appealing and its design is not ergonomic. In addition, the assembly is usually structurally complicated and contains a complex set of components, thereby contributing to a lengthy and troublesome assembly process.

### SUMMARY OF THE INVENTION

Therefore, a major objective of the present invention is to provide an integral touch-sensitive panel assembly with a robust and simplified structure for enhanced production efficiency.

The touch-sensitive panel assembly contains a back frame, a front piece, a disk module, and a panel module. The back frame contains a back piece and two lateral pieces, forming a U-like shape. The back piece has a cable opening and a connector opening. Along an inner surface adjacent to a front end of each lateral piece, two first fastening elements and a second fastening element, each with a bolt hole, are vertically arranged in this sequence. The front piece has a number of third fastening elements on a back surface, each corresponding to a first fasting element. The third fastening elements are threaded through the panel module and locked to the first fastening elements by a number of bolts.

The disk module is positioned beneath the front piece and the panel module. The disk module has fourth fastening elements corresponding to the second fastening elements of the back frame. A number of bolts are driven to lock the fourth and second fastening elements together.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a touch-sensitive panel assembly according to an embodiment of the present invention.

FIG. 2 is a perspective diagram showing the touch-sensitive panel assembly of FIG. 1 from a different vantage point.

FIG. 3 is a perspective break-down diagram showing the various components of the touch-sensitive panel assembly of FIG. 1.

FIG. 4 is a perspective break-down diagram showing the various components of the touch-sensitive panel assembly of FIG. 1 from a different vantage point.

FIG. 5 is a perspective diagram showing an application scenario of the touch-sensitive panel assembly.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

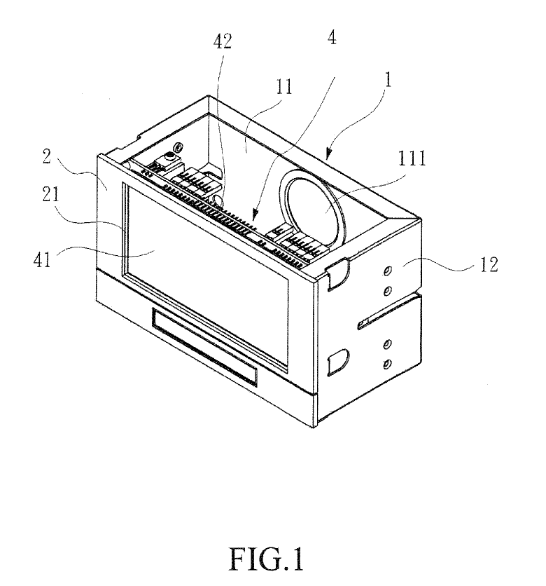

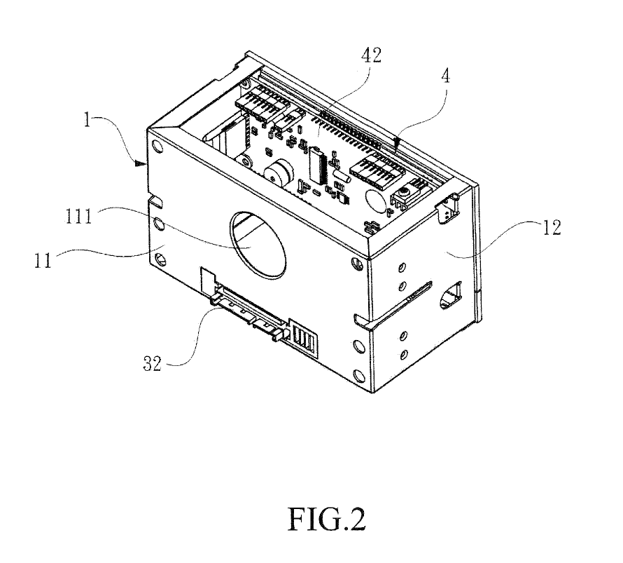

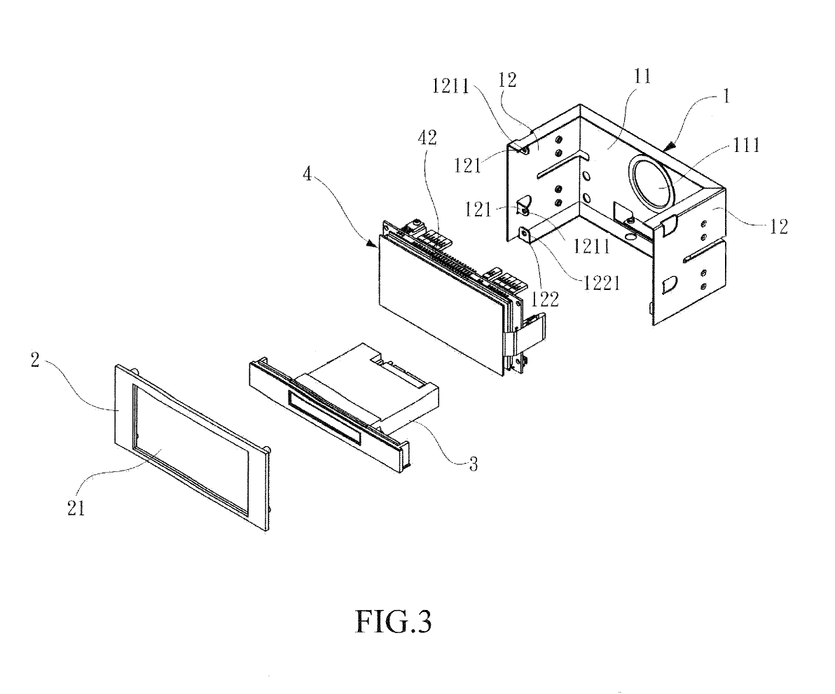

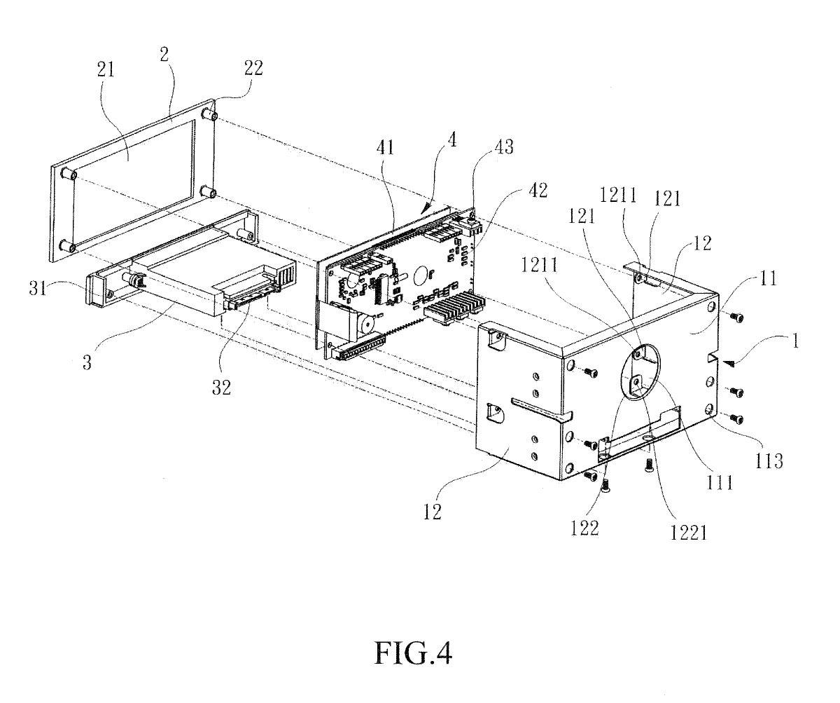

As shown in FIGS. 1 to 4, a touch-sensitive panel assembly according an embodiment of the present invention contains a back frame 1, a front piece 2, a disk module 3, and a panel module 4. The back frame 1 contains a back piece 11 and two lateral pieces 12, forming a U-like shape. On the back piece 11, a cable opening 111 and a connector opening are provided. Along an inner surface adjacent to a front end of each lateral piece 12, two first fastening elements 121 and a second fastening element 122 are vertically arranged in this sequence. The fastening elements 121 and 122 have bolts holes 1211 and 1221, respectively.

The front piece 2 has a panel opening 21 for the exposure and embedment of a touch-sensitive panel. On a back surface of the front piece 2, a number of third fastening elements 22 are provided, each corresponding to a first fasting element 121.

The panel module 4 contains a touch-sensitive panel 41 and a circuit board 42 behind the touch-sensitive panel 41. A number of through holes 43 are provided along the circumference of the circuit board 42.

The panel assembly is assembled as follows. The third fastening elements 22 of the front piece 2 are threaded through the through holes 43 of the panel module 4 and aligned with the first fastening elements 121 of the back frame 1. Then a number of bolts are driven through bolt holes 113 into the third and first fastening elements 22 and 121. The front piece 2, the panel module 4, and the back frame 1 are thereby locked together. Various cables of the panel module 4 could be threaded out of the panel assembly through the cable opening 111 for connection with other devices.

The disk module 3 is positioned beneath the front piece 2 and the panel module 4. The disk module 3 has a number of connectors 32 along a back side. There are fourth fastening elements 31 corresponding to the second fastening elements 122 of the back frame 1. A number of bolts are driven through bolt holes 113 into the fourth and second fastening elements 31 and 122. The disk module 3 are thereby locked to the back frame 1 with the connectors 32 exposed from the connector opening.

After the foregoing process, the touch-sensitive panel assembly is an integral unit that could be conveniently integrated into other device.

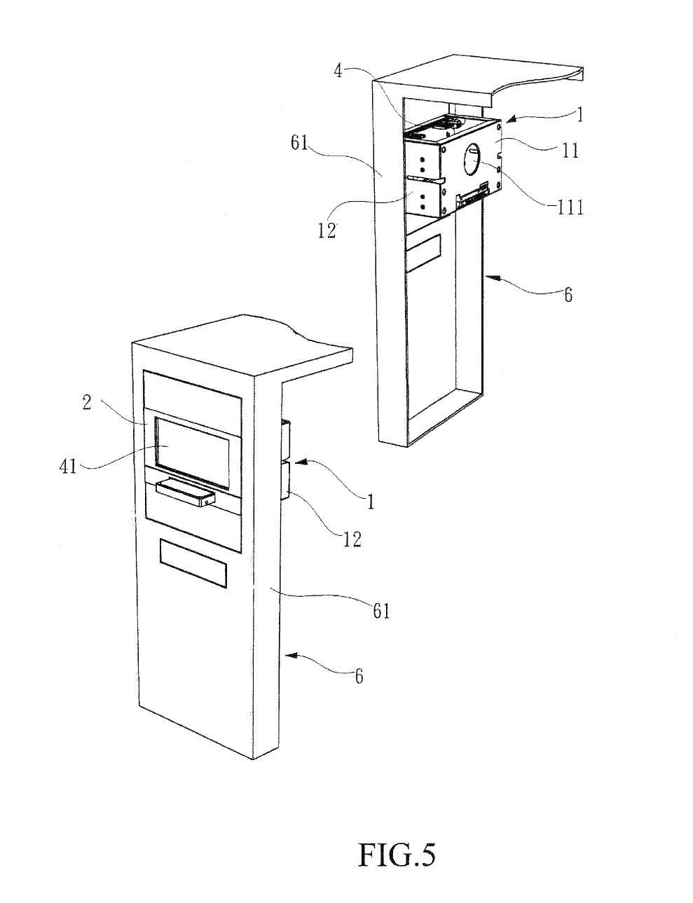

For example, as shown in FIG. 5, the panel assembly is incorporated into a front cover of a computer's tower case. As illustrated, after the panel assembly is formed as described above, it is integrated with a computer 6's front cover member 61 and the touch-sensitive panel 41 is exposed from the front cover member 61 for touch-sensitive operation of the computer 6.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A touch-sensitive panel assembly, comprising
a panel module having a touch-sensitive panel and a circuit board behind said touch-sensitive panel where a plurality of through holes are provided along said the circuit board's circumference;
a back frame having a back piece and two lateral pieces, forming a U-like shape where said back piece has a plurality of bolt holes, and, along an inner surface adjacent to a front end of each lateral piece, at least two first fastening elements and at least a second fastening element, each with a bolt hole, are vertically arranged in this sequence;
a front piece having a panel opening and a plurality of third fastening elements on a back surface of said front piece, where each said third fastening element is threaded through a said through hole of said panel module, and aligned with a said first fastening element, a plurality of bolts are driven through said back frame's bolt holes and lock said third and fourth fastening elements together, with said touch-sensitive panel exposed from said panel opening; and
a disk module positioned beneath said front piece and said panel module having a plurality of connectors along a back side and a plurality of fourth fastening elements, each corresponding to a said second fastening elements of said back frame, where a plurality of bolts are driven through bolt holes of said back frame to lock said fourth and second fastening elements together.

2. The touch-sensitive panel assembly according to claim 1, wherein said back piece has a cable opening allowing cables to and from said circuit board to run through.

3. The touch-sensitive panel assembly according to claim 1, wherein said back piece has a connector opening allowing said connectors of said disk module to be exposed.
